(19) United States
(12) Patent Application Publication
(10) Pub. No.: US 2004/0209017 A1
(43) Pub. Date: Oct. 21, 2004

(54) Weak base modification of porous ink-jet media coating for enhanced image quality

(76) Inventors: Peter C. Zahrobsky, San Diego, CA (US); Matthew Thornberry, Corvallis, OR (US); Palitha Wickramanayake, Corvallis, OR (US); Urs Fuerholz, Marly (CH); Linda C. Uhlir-Tsang, Corvallis, OR (US); Eric L. Burch, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/774,917

(22) Filed: Feb. 6, 2004

Related U.S. Application Data
(63) Continuation-in-part of application No. 10/417,243, filed on Apr. 15, 2003.

(51) Int. Cl. B41M 5/00

(52) U.S. Cl. 428/32.34

(57) ABSTRACT

A method for the preparation of a print medium that helps to reduce unwanted print artifacts such as bronzing, gloss non-uniformity, print smudging, and coalescence. Specifically, a method can comprise a step of preparing a coating composition with an acidic pH and a step of coating a media substrate with the coating composition to form an ink-receiving layer thereon. The coating composition can comprise a dispersion of inorganic particulates, a polymeric binder, and a weak base comprising a salt of an alkali metal and a weak acid. The weak base generates gas bubbles in the coating composition as a result of the acidic pH.

This continuation-in-part application claims priority of U.S. patent application Ser. No. 10/417,243, filed Apr. 15, 2003.

### FIELD OF THE INVENTION

The present invention relates generally to ink-jet media and methods for reducing unwanted print artifacts on printed images. More particularly, the present invention relates to preparing an ink-receiving layer with weak base comprising a salt of an alkali metal and a weak acid.

### BACKGROUND OF THE INVENTION

In ink-jet technology, image quality of high-resolution images can be a function of both the ink-jet ink used to produce an image, and the print medium upon which the image is printed. Desirable attributes of print quality include saturated colors, high gloss and gloss uniformity, freedom of grain and coalescence, and high degree of image permanence, among other characteristics.

With respect to much of the print media currently on the market, printed images commonly have undesirable attributes. One such undesirable attribute is bronzing, which is an optical phenomenon resulting in a metallic luster that is observed when the printed image is viewed at a particular angle. Along with bronzing, hue is usually changed from an intended hue to an unintended hue, and degradation in surface gloss quality and optical density can also result. It is believed that bronzing occurs as a result of ink aggregates forming on the surface of the print medium. While bronzing is most noticeable with black or blue inks, many inks also can exhibit similar artifactual problems. With colored inks, bronzing is more noticeable as the color density gets higher, such as in the case of secondary colors. The reduction or elimination bronzing on a printed image can contribute to higher gloss quality and better gloss uniformity.

Another gloss defect caused by printing is haze formation. Haze manifests itself in an imaged area, causing that area to appear milky. Formation of haze on a printed image can give the image a dull appearance, which can be measured by a loss of color gamut.

Another print defect that can occur is related to hue angle change. If not corrected through the color rendering process, a hue angle shift can result in colors appearing different than what is typically expected. This is especially noticeable for neutral colors that acquire a color cast, as well as for skin tones. Reducing or eliminating hue angle shifts on a printed image can contribute to improved color reproduction, especially when custom color maps are not available.

As such, it would be beneficial to develop print media that provided for reduced bronzing and other unwanted artifacts on printed images, even when utilizing a wide variety of ink-jet inks.

### SUMMARY OF THE INVENTION

It has been recognized that it would be advantageous to develop a print medium that reduces unwanted print artifacts such as bronzing, gloss non-uniformity, print haze, color shift, and coalescence. Specifically, a method of producing a print medium is disclosed, comprising steps of preparing a coating composition with an acidic pH and coating a media substrate with the coating composition to form an ink-receiving layer thereon. The coating composition can comprise a dispersion of inorganic particulates, a polymeric binder, and a weak base including a salt of an alkali metal and a weak acid.

In accordance with an alternative detailed aspect of the present invention, a print medium designed to reduce unwanted print artifacts can include a media substrate and an ink-receiving layer applied to the media substrate. The ink-receiving layer can comprise a dispersion of inorganic particulates, a polymeric binder, and gas generated bubbles located within the ink-receiving layer.

In another aspect of the present invention, a printed image on a print medium exhibiting reduced unwanted print artifacts can include a media substrate, an ink-receiving layer applied to the media substrate, and ink-jet ink printed on or within at least a portion of the ink-receiving layer. The ink-receiving layer can comprise a dispersion of inorganic particulates, a polymeric binder, and a salt of an alkali metal and a carbonate or bicarbonate species.

Additional features and advantages of the invention will be apparent from the following detailed description which illustrates, by way of example, features of the invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a colorant” includes reference to one or more of such materials.

An “ink” or “ink-jet ink” refers to a liquid solution or dispersion composition that can comprise a liquid vehicle and a colorant, e.g., pigment and/or dye. The liquid vehicle can be configured to be stable with the pigment and/or dye through a broad range of solution characteristics, and can be configured for ink-jet printing.

The term “colorant” refers to pigments and dyes. Dyes are typically anionic dyes, and pigments can be self-dispersed or dispersant dispersed.

As used herein, “liquid vehicle” is defined to include liquid compositions that can be used to carry colorants to a substrate. Liquid vehicles are well known in the art, and a wide variety of ink vehicles may be used in accordance with embodiments of the present invention. Such ink vehicles may include a mixture of a variety of different agents, including without limitation, surfactants, solvents, cosolvents, buffers, biocides, viscosity modifiers, sequestering agents, stabilizing agents, and water. The liquid vehicle can also carry other additives such as polymers, UV curable materials, and/or plasticizers in some embodiments.

“Bronzing” refers to an optical phenomenon resulting in a metallic luster that is observed when a printed image is viewed at a particular angle. Hue is usually changed from the intended hue, and a reduction in surface gloss and optical density can also result. It is believed that bronzing is a result of ink aggregates on the surface of the print medium. While bronzing is most noticeable with black inks, color inks also can exhibit similar artifactual problems. With color inks, bronzing is more noticeable as the color density gets higher, such as in the case of secondary colors. Reducing or eliminating bronzing of the printed image contributes to higher gloss and better gloss uniformity.

“Media substrate” or “substrate” includes any substrate that can be coated with a coating composition (to form an ink-receiving layer) of the present invention, and can include papers, overhead projector plastics or films, coated papers such as photobase, fabric, art paper such as water color paper, or the like.

The term “print medium” or “print media” refers to media substrate(s) that are coated with an ink-receiving layer.

“Acid” refers to any compound that has a pKa below 7 and can be used to lower the pH of a composition below 7.

As used herein, “acidic pH” defines the pH of compositions that are below 7.

“Porous media” refers to any substantially inorganic particulate-containing coated media having surface voids and/or cavities capable of taking in the ink-jet inks of the present invention. Typically, porous media includes a substrate and a porous ink-receiving layer. As ink is printed on the porous media, the ink can fill the voids and the outermost surface can become dry to the touch in a more expedited manner as compared to traditional or swellable media. Common inorganic particulates that can be present in the coatings include silica and alumina. Additionally, such coatings are typically bound together by a polymeric binder, and optionally, can include mordants or ionic binding species that are attractive of classes of predetermined dye species. In accordance with embodiments of the present invention, the porous media can include an ink-receiving layer prepared from a coating composition having a weak base including a salt of an alkali metal and a weak acid, which can interact to generate gas bubbles to improve coating dispersion properties, or additionally, to provide gas generated voids or bubbles within the ink-receiving layer.

The term “gas generated bubbles” refers to voids that can remain present in an ink-receiving layer as a result of generated gas. The voids do not have to ultimately contain the generated gas, as the generated gas may be replaced with air over time.

The term “about” when referring to a numerical value or range is intended to encompass the values resulting from experimental error that can occur when taking measurements.

Concentrations, amounts, measurements, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

In accordance with various embodiments of the present invention, a method is disclosed for producing a print medium that results in a reduction of unwanted print artifacts such as bronzing, gloss non-uniformity, hazing, color shift, print smudging, and coalescence. The resulting print medium can include a porous ink-receiving layer that may contain from a residual amount to a larger amount of gas generated bubbles, depending on the coating properties desired. The bubbles are primarily used to decrease the energy required to disperse inorganic particulates into the coating composition used to form the ink-receiving layer. This increased dispersing effect in turn can decrease artifacts associated with the coalescence of colorant on the surface of the print medium.

Another embodiment of the present invention provides a method of producing a print medium that results in a reduction of unwanted print artifacts. In one step of the method, a coating composition having an acidic pH is prepared that comprises a dispersion of inorganic particulates, a polymeric binder, and a a weak base including a salt of an alkali metal and a weak acid. The salt can generate gas bubbles in the coating composition as a result of acidic pH, which can be provided by the presence of an acid. The method can also include a step of coating a media substrate with the coating composition to form an ink-receiving layer thereon. Some of the generated gas bubbles can produce voids that remain present in the ink-receiving layer, or alternatively, the gas bubbles can be more fully dissipated prior to the coating step.

In another embodiment, a print medium is disclosed that can be used to reduce unwanted print artifacts. The print medium comprises a media substrate and an ink-receiving layer applied to the media substrate. The ink receiving layer can comprise a dispersion of inorganic particulates, a polymeric binder, and gas generated bubbles. The bubbles can be generated by reacting an acid with a weak base, including a salt of an alkali metal and a weak acid, within a coating composition, which can be then coated on a media substrate to form the ink-receiving layer.

In another embodiment, a printed image on a print medium exhibiting reduced unwanted artifacts is disclosed. The printed image comprises a media substrate, an ink receiving layer applied to the media substrate, and an ink-jet ink printed on or within at least a portion of the ink-receiving layer. The ink receiving layer can comprise a dispersion of inorganic particulates, a polymeric binder, and a salt of an alkali metal and a carbonate or bicarbonate species. Optionally, gas bubbles generated in a coating composition used to form the ink-receiving layer can generate voids within the ink-receiving layer, or alternatively, the gas bubbles can be more fully dissipated prior to application of the ink-receiving layer.

In each of the above embodiments, rather than applying a coating in accordance with embodiments of the present invention directly to a paper or another media substrate, topcoat compositions can be prepared that can be applied to coated media substrates. Such coated media substrates can also result in a reduction of unwanted print artifacts upon printing. In this embodiment, a topcoat can be applied to a coated media substrate, which coated media substrate may already include an ink-receiving layer in accordance with embodiments of the present invention, or can include another ink-receiving layer generally known in the art in order to control surface interaction between the ink and the coating.

Porous Media Coatings

In accordance with one aspect of the present invention, systems, methods, coated media, and ink-jet prints are provided. The coated media typically includes a substrate and a porous ink-receiving layer deposited on the substrate. The substrate can be paper, plastic, coated paper, fabric, art paper, or other known substrate used in the ink-jet printing arts. In one embodiment, photobase can be used as the substrate. Photobase is typically a three-layered system comprising a single layer of paper sandwiched by two polymeric layers, such as polyethylene layers.

With respect to the porous ink-receiving layer, inorganic semi-metal or metal oxide particulates, polymeric binder, a weak base including a salt of an alkali metal and a weak acid, and optionally, mordants and/or other coating composition agents can be present. In one embodiment, the inorganic semi-metal or metal oxide particulates can be silica, alumina, boehmite, silicates (such as aluminum silicate, magnesium silicate, and the like), titania, zirconia, calcium carbonate, clays, and derivatives thereof. In a more detailed aspect, the particulates can be alumina, silica, or aluminosilicate. Each of these inorganic particulates can be dispersed throughout a coating composition, which can be applied to a media substrate to form the porous ink-receiving layer. Typically, the inorganic particulates are present in the coating composition at from 60 wt % to 95 wt %. In a few specific embodiments, boehmite can be present in the coating composition at from 85 wt % to 95 wt %, or silica or silicates can be present in the coating composition at from 75 wt % to 85 wt %.

In order to bind the inorganic particulates together in the coating composition, a polymeric binder is typically included. Exemplary polymeric binders that can be used include polyvinyl alcohol including water-soluble copolymers thereof; polyvinyl acetate; polyvinyl pyrrolidone; modified starches including oxidized and etherified starches; water soluble cellulose derivatives including carboxymethyl cellulose, hydroxyethyl cellulose; polyacrylamide including its derivatives and copolymers; casein; gelatin; soybean protein; silyl-modified polyvinyl alcohol; conjugated diene copolymer latexes including maleic anhydride resin, styrene-butadiene copolymer, and the like; acrylic polymer latexes including polymers and copolymers of acrylic and methacrylic acids, and the like; vinyl polymer latexes including ethylene-vinyl acetate copolymers; functional group-modified latexes including those obtained by modifying the above-mentioned polymers with monomers containing functional groups (e.g. carboxyl, amino, amido, sulfo, etc.); aqueous binders of thermosetting resins including melamine resins, urea resin, and the like; synthetic resin binders including polymethyl methacrylate, polyurethane resin, polyester resin, amide resin, vinyl chloride-vinyl acetate copolymer, polyvinyl butyral, and alkyl resins. Such binder can be present to bind the porous ink-receiving layer together, but can also be present in small enough amounts to maintain the porous nature of the porous ink-receiving layer. In accordance with embodiments of the present invention, the polymeric binder can be present in the coating composition at from 5 wt % to 40 wt %. In specific embodiments where boehmite is used, the polymeric binder can be present at from 3 wt % to 15 wt %. Alternatively, where silica or silicates are used, the polymeric binder can be present at from 10 wt % to 25 wt %. In another specific embodiment, the binder can be polyvinyl alcohol or derivatives thereof.

With respect to the weak base including the salt of the alkali metal and the weak acid, any weak base that generates gas bubbles in the presence of an acid or a composition having an acidic pH would be deemed to be within the scope of the present invention. In one embodiment of the present invention, for example, the weak base reacts with the acid to form CO₂ bubbles. Examples of weak bases that generate CO₂ in the presence of an acid include alkali salts of carbonates, including bicarbonates.

The alkali metal component of the salt can include any Group I metal on the periodical chart, namely lithium, sodium, potassium, rubidium, cesium, and/or francium. Practically, however, alkali metals that can be used to prepare weak bases are lithium, sodium, and potassium. Accordingly, typical weak bases comprising salts of an alkali metal and a weak acid can be used, including sodium carbonate, sodium bicarbonate, lithium carbonate, lithium bicarbonate, potassium carbonate, potassium bicarbonate, and various mixtures thereof. Carbonates or bicarbonates of lithium or sodium can be preferred for use as weak bases in some embodiments. It should be noted that this list is merely illustrative of weak base alkali metal carbonate examples, and is not intended to limit the scope of the present invention.

In one embodiment of the present invention, an acid can be included in the coating composition to react with the weak base in order to form gas bubbles in the coating composition. The acid can include any composition that can lower or maintain the pH of the coating composition below about 7. Examples of acids that may be included in the coating composition include, but are not limited to, inorganic mineral acids such as HCl, H₂SO₄, HNO₃, or the like; or organic acids such as acetic acid, lactic acid, propionic acid, or the like. Additionally, the acid in the coating composition can be provided by an acidic cross linking agent, such as, but not limited to, boric acid or boric acid salts, melamine, formaldehyde derivatives, epoxy curing agents, amine curing agents, or the like.

The inorganic particulates can also add an acid property, the coating composition and the resulting ink-receiving layer. For example, silica can act as an acid lowering the pH of the composition. In other words, any functional material that acts to lower the pH can be added as the acid component, e.g., acid or acidic material, at the appropriate time to generate gas.

In one embodiment, the alkali metal can remain present in the ink-receiving layer (after gas generation) at from about 0.4 wt % to about 10 wt %. In another embodiment, the salt can be added to the coating composition used to form the ink-receiving layer at from about 0.001 wt % to about 10 wt %. Similarly, the salt can be added to the coating composition in an amount designed to adjust the pH of the coating composition to a particular range. For example, in one embodiment of the present invention, a working pH range of the coating composition can be from about 2.0 to about 6.0. In another embodiment, the working pH range of the coating composition can be from about 3.0 to about 4.5. Further, the pH of the ink-receiving layer prepared from the coating composition typically has a pH that is below about 7 (as measured by the application of a pH sensor probed to a drop of water on media surface). In some embodiments, the pH can also be from 2.0 to 6.0, and in other embodiments, from about 3.0 to 4.5.

Optionally, the porous ink-receiving layer can also be modified with an ionic binding species or mordant known to interact with a predetermined class of colorants, thereby increasing permanence. Typical mordants that can be included in the coating composition (and thus, included in the porous ink-receiving layer) include hydrophilic, water dispersible, or water soluble polymers having cationic groups (amino, tertiary amino, amidoamino, pyridine, imine, and the like). These cationically modified polymers can be compatible with water-soluble or water dispersible binders and have little or no adverse effect on image processing or colors present in the image. Suitable examples of such polymers include, but are not limited to, polyquaternary ammonium salts, cationic polyamines, polyamidins, cationic acrylic copolymers, guanidine-formaldehyde polymers, polydimethyl diallylammonium chloride, diacetone acrylamide-dimethyldiallyl ammonium chloride, polyethyleneimine, and a polyethyleneimine adduct with epichlorhydrin. Aside from mordants, other optional components that can be present in the porous ink-receiving layer can include anionic surfactants, cationic surfactants, biocides, plasticizers, optical brighteners, viscosity modifiers, leveling agents, UV absorbers, hindered amine stabilizers, anti-ozonants, silane coupling agents, and/or other known additives.

The ink-receiving layer can be a single layer or a multilayer coating designed to absorb sufficient quantities of ink to produce high quality printed images. The coating composition may be applied to the media substrate to form the ink-receiving layer by any means known to one skilled in the art, including blade coating, air knife coating, rod coating, wire rod coating, roll coating, slot coating, slide hopper coating, gravure, and curtain coating. The ink-receiving layer can be printed on one or both sides of the media substrate. In one embodiment of the present invention, the depth of the ink-receiving layer formed by the coating composition can be from about 20 μm to about 60 μm. In accordance with a few specific embodiments, the thickness for boehmite-containing coating compositions can be from 40 μm to 55 μm, the thickness for silica- or silicate-containing coating compositions can be from 25 μm to 35 μm. If applied as a media topcoat, the thickness can range from 0.1 μm to 10 μm, and in a more specific embodiment, from 1 μm to 5 μm.

In one embodiment of the present invention, the gas generated bubbles begin to form in the wet coating composition. As the coating composition is applied to the media substrate and begins to dry, the bubbles become fixed throughout the ink-receiving layer. Typically, the average diameter of the bubbles can be less than about 10 μm. In another embodiment, the average diameter of the bubbles can be from about 0.01 μm to about 0.1 μm.

Ink-Jet Ink

The ink-jet ink compositions that can be used to form the printed images of the present invention are typically prepared in an aqueous formulation or liquid vehicle which can include water, colorants, cosolvents, surfactants, buffering agents, biocides, sequestering agents, viscosity modifiers, humectants, binders, and/or other known additives. Typically, the ink-jet ink compositions of the present invention have a viscosity of between about 0.8 to about 8 cps, though broader ranges can be functional. In one aspect of the present invention, the liquid vehicle can comprise from about 70 wt % to about 99.9 wt % by weight of the ink-jet ink composition. In another aspect, the liquid vehicle can also carry polymeric binders, latex particulates, and/or other solids.

As described, cosolvents can be included in the ink-jet compositions of the present invention. Suitable cosolvents for use in the present invention include water soluble organic cosolvents, but are not limited to, aliphatic alcohols, aromatic alcohols, diols, glycol ethers, poly(glycol) ethers, lactams, formamides, acetamides, long chain alcohols, ethylene glycol, propylene glycol, diethylene glycols, triethylene glycols, glycerin, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. For example, cosolvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides. Specific examples of cosolvents that are preferably employed in the practice of this invention include, but are not limited to, 1,5-pentanediol, 2-pyrrolidone, 2-ethyl-2-hydroxymethyl-1,3-propanediol, diethylene glycol, 3-methoxybutanol, and 1,3-dimethyl-2-imidazolidinone. Cosolvents can be added to reduce the rate of evaporation of water in the ink-jet to minimize clogging or other properties of the ink such as viscosity, pH, surface tension, optical density, and print quality. The cosolvent concentration can range from about 5 wt % to about 25 wt %, and in one embodiment is from about 10 wt % to about 20 wt %. Multiple cosolvents can also be used, as is known in the art.

Various buffering agents or pH adjusting agents can also be optionally used in the ink-jet ink compositions of the present invention. Typical buffering agents include such pH control solutions as hydroxides of alkali metals and amines, such as lithium hydroxide, sodium hydroxide, potassium hydroxide; citric acid; amines such as triethanolamine, diethanolamine, and dimethylethanolamine; hydrochloric acid; and other basic or acidic components which do not substantially interfere with the bleed control or optical density characteristics of the present invention. If used, buffering agents typically comprise less than about 10 wt % of the ink-jet ink composition.

In another aspect of the present invention, various biocides can be used to inhibit growth of undesirable microorganisms. Several non-limiting examples of suitable biocides include benzoate salts, sorbate salts, commercial products such as NUOSEPT (Nudex, Inc., a division of Huls America), UCARCIDE (Union Carbide), VANCIDE (RT Vanderbilt Co.), and PROXEL (ICI Americas) and other known biocides. Typically, such biocides comprise less than about 5 wt % of the ink-jet ink composition and often from about 0.1 wt % to about 0.25 wt %.

In an additional aspect of the present invention, binders can be included which act to secure the colorants on the substrate. Binders suitable for use in the present invention typically have a molecular weight of from about 500 Mw to about 5,000 Mw. Non-limiting examples include polyester, polyester-melanine, styrene-acrylic acid copolymers, styrene-acrylic acid-alkyl acrylate copolymers, styrene-maleic acid copolymers, styrene-maleic acid-alkyl acrylate copolymers, styrene-methacrylic acid copolymers, styrene-methacrylic acid-alkyl acrylate copolymers, styrene-maleic half ester copolymers, vinyl naphthalene-acrylic acid copolymers, vinyl naphthalene-maleic acid copolymers, and salts thereof.

If surfactants are used, then typical water-soluble surfactants such as alkyl polyethylene oxides, alkyl phenyl polyethylene oxides, polyethylene oxide (PEO) block copolymers, acetylenic PEO, PEO esters, PEO amines, PEO amides, and dimethicone copolyols can be used. Such surfactants can be present at from 0.01% to about 10% by weight of the ink-jet ink composition.

Colorants included in the ink-jet ink of the printed image embodiment of the present invention can be dyes and/or pigments. With respect to the various ink-jet ink dyes, either a cationic dye or an anionic dye can be used. In one embodiment of the present invention, the anionic dye can be a chromaphore having a pendent anionic group. Though any effective amount of dye can be used, preferably, the anionic dye can be present in the ink composition at from about 0.1 wt % to about 10 wt %. Examples of suitable anionic dyes that can be used include a large number of water-soluble acid and direct dyes. Specific examples of anionic dyes include the Pro-Jet series of dyes available from Avecia Ltd., including Pro-Jet Yellow I (Direct Yellow 86), Pro-Jet Magenta I (Acid Red 249), Pro-Jet Cyan I (Direct Blue 199), Pro-Jet Black I (Direct Black 168), and Pro-Jet Yellow 1-G (Direct Yellow 132); Aminyl Brilliant Red F-B (Sumitomo Chemical Co.); the Duasyn line of “salt-free” dyes available from Hoechst, such as Duasyn Direct Black HEF-SF (Direct Black 168), Duasyn Black RL-SF (Reactive Black 31), Duasyn Direct Yellow 6G-SF VP216 (Direct Yellow 157), Duasyn Brilliant Yellow GL-SF VP220 (Reactive Yellow 37), Duasyn Acid Yellow XX-SF VP413 (Acid Yellow 23), Duasyn Brilliant Red F3B-SF VP218 (Reactive Red 180), Duasyn Rhodamine B-SF VP353 (Acid Red 52), Duasyn Direct Turquoise Blue FRL-SF VP368 (Direct Blue 199), and Duasyn Acid Blue AE-SF VP344 (Acid Blue 9); mixtures thereof; and the like. Further examples include Tricon Acid Red 52, Tricon Direct Red 227, and Tricon Acid Yellow 17 (Tricon Colors Incorporated), Bernacid Red 2BMN, Pontamine Brilliant Bond Blue A, BASF X-34, Pontamine, Food Black 2, Catodirect Turquoise FBL Supra Conc. (Direct Blue 199, Carolina Color and Chemical), Special Fast Turquoise 8GL Liquid (Direct Blue 86, Mobay Chemical), Intrabond Liquid Turquoise GLL (Direct Blue 86, Crompton and Knowles), Cibracron Brilliant Red 38-A (Reactive Red 4, Aldrich Chemical), Drimarene Brilliant Red X-2B (Reactive Red 56, Pylam, Inc.), Levafix Brilliant Red E-4B (Mobay Chemical), Levafix Brilliant Red E-6BA (Mobay Chemical), Pylam Certified D&C Red #28 (Acid Red 92, Pylam), Direct Brill Pink B Ground Crude (Crompton & Knowles), Cartasol Yellow GTF Presscake (Sandoz, Inc.), Tartrazine Extra Conc. (FD&C Yellow #5, Acid Yellow 23, Sandoz, Inc.), Catodirect Yellow RL (Direct Yellow 86, Carolina Color and Chemical), Cartasol Yellow GTF Liquid Special 110 (Sandoz, Inc.), D&C Yellow #10 (Yellow 3, Tricon), Yellow Shade 16948 (Tricon), Basacid Black X34 (BASF), Carta Black 2GT (Sandoz, Inc.), Neozapon Red 492 (BASF), Orasol Red G (Ciba-Geigy), Direct Brilliant Pink B (Crompton-Knolls), Aizen Spilon Red C-BH (Hodagaya Chemical Company), Kayanol Red 3BL (Nippon Kayaku Company), Levanol Brilliant Red 3BW (Mobay Chemical Company), Levaderm Lemon Yellow (Mobay Chemical Company), Aizen Spilon Yellow C-GNH (Hodagaya Chemical Company), Spirit Fast Yellow 3G, Sirius Supra Yellow GD 167, Cartasol Brilliant Yellow 4GF (Sandoz), Pergasol Yellow CGP (Ciba-Geigy), Orasol Black RL (Ciba-Geigy), Orasol Black RLP (Ciba-Geigy), Savinyl Black RLS (Sandoz), Dermacarbon 2GT (Sandoz), Pyrazol Black BG (ICI Americas), Morfast Black Conc A (Morton-Thiokol), Diazol Black RN Quad (ICI Americas), Orasol Blue GN (Ciba-Geigy), Savinyl Blue GLS (Sandoz, Inc.), Luxol Blue MBSN (Morton-Thiokol), Sevron Blue 5GMF (ICI Americas), and Basacid Blue 750 (BASF); Levafix Brilliant Yellow E-GA, Levafix Yellow E2RA, Levafix Black EB, Levafix Black E-2G, Levafix Black P-36A, Levafix Black PN-L, Levafix Brilliant Red E6BA, and Levafix Brilliant Blue EFFA, all available from Bayer; Procion Turquoise PA, Procion Turquoise HA, Procion Turquoise Ho5G, Procion Turquoise H-7G, Procion Red MX-5B, Procion Red H₈B (Reactive Red 31), Procion Red MX 8B GNS, Procion Red G, Procion Yellow MX-8G, Procion Black H-EXL, Procion Black P-N, Procion Blue MX-R, Procion Blue MX-4GD, Procion Blue MX-G, and Procion Blue MX-2GN, all available from ICI Americas; Cibacron Red F-B, Cibacron Black BG, Lanasol Black B, Lanasol Red 5B, Lanasol Red B, and Lanasol Yellow 46, all available from Ciba-Geigy; Baslien Black P-BR, Baslien Yellow EG, Baslien Brilliant Yellow P-3GN, Baslien Yellow M-6GD, Baslien Brilliant Red P-3B, Baslien Scarlet E-2G, Baslien Red E-B, Baslien Red E-7B, Baslien Red M-5B, Baslien Blue E-R, Baslien Brilliant Blue P-3R, Baslien Black P-BR, Baslien Turquoise Blue P-GR, Baslien Turquoise M-2G, Baslien Turquoise E-G, and Baslien Green E-6B, all available from BASF; Sumifix Turquoise Blue G, Sumifix Turquoise Blue H-GF, Sumifix Black B, Sumifix Black H-BG, Sumifix Yellow 2GC, Sumifix Supra Scarlet 2GF, and Sumifix Brilliant Red 5BF, all available from Sumitomo Chemical Company; Intracron Yellow C-8G, Intracron Red C-8B, Intracron Turquoise Blue GE, Intracron Turquoise HA, and Intracron Black RL, all available from Crompton and Knowles, Dyes and Chemicals Division; mixtures thereof, and the like. This list is intended to be merely exemplary, and should not be considered limiting.

With respect to the various ink-jet ink pigments that can be used, the base pigment that can be modified and used can be of any color, such as black, magenta, cyan, or yellow, for example. Though the present invention can use any color of pigment, exemplary black pigments that can be used are specifically provided. Specifically, black pigments that can be used include carbon pigments. The carbon pigment can be almost any commercially available carbon pigment that provides acceptable optical density and print characteristics. Carbon pigments suitable for use in the present invention include, without limitation, carbon black, graphite, vitreous carbon, charcoal, and combinations thereof. Such carbon pigments can be manufactured by a variety of known methods such as a channel method, a contact method, a furnace method, an acetylene method, or a thermal method, and are commercially available from such vendors as Cabot Corporation, Columbian Chemicals Company, Degussa AG, and E.I. DuPont de Nemours and Company. Suitable carbon black pigments include, without limitation, Cabot pigments such as MONARCH 1400, MONARCH 1300, MONARCH 1100, MONARCH 1000, MONARCH 900, MONARCH 880, MONARCH 800, MONARCH 700, CAB-O-JET 200, and CAB-O-JET 300; Columbian pigments such as RAVEN 7000, RAVEN 5750, RAVEN 5250, RAVEN 5000, and RAVEN 3500; Degussa pigments such as Color Black FW 200, RAVEN FW 2, RAVEN FW 2V, RAVEN FW 1, RAVEN FW 18, RAVEN S160, RAVEN FW S170, Special Black 6, Special Black 5, Special Black 4A, Special Black 4, PRINTEX U, PRINTEX 140U, PRINTEX V, and PRINTEX 140V; and TIPURE R-101 available from Dupont. The above list of pigments includes unmodified pigment particulates, small molecule attached pigment particulates, and polymer-dispersed pigment particulates. Unmodified pigments can be modified with small molecules or polymers to be used in accordance with embodiments of the present invention.

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following Examples provide further detail in connection with what are presently deemed to be the most practical and preferred embodiments of the invention.

### Example 1

### Preparation of Silica Dispersion Including Lithium Carbonate

To an amount of deionized water sufficient to prepare a 25 wt % solids dispersion is added various components, each of which is expressed in solids content by weight. Specifically, to the water is added 3.1 parts of lithium carbonate mixed with high lift using a paddle blade mixer until the lithium carbonate is dissolved. To this solution is added 26.7 parts of aluminum chlorohydrate under continued mixing. Next, 236.2 parts of fumed silica are added portion-wise using a paddle blade mixer (pH<7). Once the silica is wetted, the composition is mixed under high shear until substantially homogenous. The mixing is then changed to a gentle mixing setting and the composition is warmed to 60° C. overnight.

### Example 2

### Preparation of Silica Dispersion with Reduced Amount of Lithium Carbonate

A silica dispersion is prepared as described in Example 1, except that only half of the amount of lithium carbonate is added.

### Example 3

### Preparation of Silica Dispersion with No Lithium Carbonate

A silica dispersion is prepared as described in Example 1, except that no lithium carbonate is added.

### Example 4

### Preparation of Coating Compositions

Each additive of this example is described in accordance with its solids content by weight. Three different coating compositions are prepared, each including a different silica dispersion in accordance with Examples 1-3, respectively. Under continued mixing, to each dispersion (120.9 parts) is added 4.3 parts boric acid, 2.5 parts diethylene glycol, 1.7 parts glycerol, 0.3 parts surfactant, and 30.2 parts Mowiol 2688 (polyvinyl alcohol). To each of the mixtures is separately added enough deionized water under gentle mixing to achieve a16 wt % solids content based on each complete coating composition.

### Example 5

### Coating Compositions Applied to a Media Substrate

The coating compositions prepared in accordance with Example 4 are each respectively applied to a media substrate using a Meyer rod at a delivery rate of 27 gsm. The coated substrate is then dried in an oven at 60° C. More specifically, in accordance with the coating compositions set forth in Example 4, three media sheet types can be prepared. Specifically, a first coated media sheet (1) can be prepared that includes 1.3 wt % lithium carbonate based on the total fumed silica content, a second coated media sheet (2) can be prepared that includes 0.65 w % lithium carbonate based on the total fumed silica content, and a third coated media sheet (3) can be prepared as a control for comparison purposes that includes 0 wt % lithium carbonate.

### Example 6

### Print Test Results

Diagnostic images are printed on the three coated media sheets described in Example 5 (Coated Media Sheets 1-3) using an HP 6540 desktop printer having a photo pen. The diagnostic prints are used to evaluate bronzing and black neutrality using a subjective visual scale, which is set forth in Table 1, as follows:

TABLE 1

| Coated | Li₂CO₃ | Bronzing | Black neutrality |
|---|---|---|---|
| Media | (wt % of silica) | (1-poor to 5-good) | (1-poor to 5-good) |
| 1 | 1.3 | 5 | 5 |
| 2 | 0.65 | 3.5 | 4 |
| 3 | 0 | 1.5 | 1 |

### Example 7

### Thin Lithium Carbonate-Modified Topcoats Applied to Unmodified Coatings

Three coated media sheets without lithium carbonate are prepared, as previously described in Example 5 (coated media sheet 3). A topcoat coating composition is prepared as described in Example 4, except that 2.4 wt % of NaHCO₃ with respect to the fumed silica was added in place of the Li₂CO₃. The topcoat coating composition is applied to two of the three coated media sheets at 2 gsm and 4 gsm, respectively. Diagnostic images are printed on the three coated media sheets (coated media sheet 4 having no topcoat, coated media sheet 5 having a 2 gsm topcoat, and coated media sheet 6 having a 4 gsm topcoat) using an HP 6540 desktop printer having a photo pen. The diagnostic prints are used to evaluate bronzing and black neutrality using a subjective visual scale, and gamut using the CIELab gamut volume system (k). Table 2 sets forth the results, as follows:

TABLE 2

| | Topcoat | Bronzing | | Gamut |
|---|---|---|---|---|
| Coated | thickness | (1-poor to 5- | Black neutrality | (CIELab gamut |
| Media | (gsm) | good) | (1-poor to 5-good) | volume) |
| 4 | 0 | 1.5 | 1 | 304 k |
| 5 | 2 gsm | 4.5 | 4 | 431 k |
| 6 | 4 gsm | 5 | 4 | 412 k |

*Coated Media 3 of Table 1 and Coated Media 4 of Table 2 are identical.

As can be seen in Table 2, coated media with a topcoat containing the pH modifier, albeit present in a relatively thin layer, showed improvement with respect to bronzing, improved black neutrality, and improved gamut.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. A method of producing a print medium, comprising steps of:
a) preparing a coating composition having an acidic pH, said coating composition comprising:
i) a dispersion of inorganic particulates;
ii) a polymeric binder; and
iii) a weak base comprising a salt of an alkali metal and a weak acid; and
b) coating a media substrate with the coating composition to form an ink-receiving layer thereon.

2. A method as in claim 1, further comprising a step of including an acid in the coating composition that is reactive with the weak base.

3. A method as in claim 2, wherein the acid is provided by an acidic cross linking agent.

4. A method as in claim 1, wherein the weak base generates gas bubbles as a result of the acidic pH.

5. A method as in claim 4, wherein the gas bubbles are CO₂ bubbles.

6. A method as in claim 1, wherein the weak base is selected from the group consisting of alkali carbonate salt, alkali bicarbonate salt, and mixtures thereof.

7. A method as in claim 1, wherein the alkali metal is selected from the group consisting of sodium, lithium, and potassium.

8. A method as in claim 7, wherein the alkali metal is sodium.

9. A method as in claim 7, wherein the alkali metal is lithium.

10. A method as in claim 1, wherein the pH of the coating composition is from about 2.0 to about 6.0.

11. A method as in claim 10, wherein the pH of the coating composition is from about 3.0 to about 4.5.

12. A method as in claim 1, wherein the salt is added to the coating composition at from about 0.001 wt % to about 10 wt %.

13. A method as in claim 1, wherein the media substrate is a coated media substrate, and the coating composition is a topcoat to be applied to the coated media substrate.

14. A print medium, comprising:
a) a media substrate; and
b) an ink-receiving layer applied to the media substrate, said ink-receiving layer comprising:
i) a dispersion of inorganic particulates;
ii) a polymeric binder; and
iii) gas generated bubbles located within the ink-receiving layer, wherein the gas generated bubbles are generated by reacting an acid with a weak base comprising a salt of an alkali metal and a weak acid.

15. A print medium as in claim 14, wherein the ink-receiving layer contains excess amounts of the acid.

16. A print medium as in claim 14, wherein the acid is provided by an acidic cross linking agent.

17. A print medium as in claim 14, wherein the ink-receiving layer contains an excess of the weak base.

18. A print medium as in claim 14, wherein the weak base is selected from the group consisting of a carbonate, a bicarbonate, and mixtures thereof.

19. A print medium as in claim 14, wherein the alkali metal is selected from the group consisting of sodium, lithium, and potassium.

20. A print medium as in claim 19, wherein the alkali metal is sodium.

21. A print medium as in claim 19, wherein the alkali metal is lithium.

22. A print medium as in claim 14, wherein the pH of the ink-receiving layer is from about 2.0 to about 6.0.

23. A print medium as in claim 22, wherein the pH of the ink-receiving layer is from about 3.0 to about 4.5.

24. A print medium as in claim 14, wherein the alkali metal is present in the ink-receiving layer at from about 0.4 wt % to about 10 wt %.

25. A print medium as in claim 14, wherein the ink-receiving layer has an average thickness of from about 10 μm to about 60 μm.

26. A print medium as in claim 14, wherein the bubbles have an average diameter of less than about 10 μm.

27. A print medium as in claim 26, wherein the bubbles have an average diameter of from about 0.01 μm to about 0.1 μm

28. A print medium as in claim 14, wherein the media substrate is a coated media substrate, and the ink-receiving layer is applied as a topcoat to the coated media substrate.

29. A print medium as in claim 28, wherein the ink-receiving layer has an average thickness of from about 0.1 μm to about 10 μm.

30. A print medium as in claim 29, wherein the alkali metal concentration in the ink-receiving layer applied as a topcoat is greater than is present in the coated media substrate.

31. A printed image on a print medium, comprising:
a) a media substrate;
b) an ink-receiving layer applied to the media substrate, said ink-receiving layer comprising;
i) a dispersion of inorganic particulates;
ii) a polymeric binder; and
iii) a salt of an alkali metal and a carbonate or bicarbonate species; and
c) an ink-jet ink printed on at least a portion of the ink-receiving layer.

32. A printed image as in claim 31, wherein the ink-receiving layer also includes an acid reactive with the salt.

33. A printed image as in claim 32, wherein the acid is provided by an acidic cross linking agent.

34. A printed image as in claim 31, wherein the ink-receiving layer contains an excess of the carbonate or bicarbonate species.

35. A printed image as in claim 32, wherein the acid and the salt generate CO₂ bubbles, said CO₂ bubbles providing voids which remain present in the ink-receiving layer.

36. A printed image as in claim 31, wherein the alkali metal is selected from the group consisting of sodium, lithium, and potassium.

37. A printed image as in claim 36, wherein the alkali metal is sodium.

38. A printed image as in claim 36, wherein the alkali metal is lithium.

39. A printed image as in claim 31, wherein the pH of the ink-receiving layer is from about 2.0 to about 6.0.

40. A printed image as in claim 39, wherein the pH of the ink-receiving layer is from about 3.0 to about 4.5.

41. A printed image as in claim 31, wherein the alkali metal is present in the ink-receiving layer at from about 0.4 wt % to about 10 wt %.

42. A printed image as in claim 31, wherein the ink-receiving layer has an average thickness of from about 10 μm to about 60 μm.

43. A printed image as in claim 35, wherein the bubbles have an average diameter of less than about 10 μm.

44. A printed image as in claim 35, wherein the bubbles have an average diameter of from about 0.01 μm to about 0.1 μm.

45. A printed image as in claim 31, wherein the media substrate is a coated media substrate, and the ink-receiving layer is applied as a topcoat to the coated media substrate.

46. A printed image as in claim 45, wherein the ink-receiving layer has an average thickness of from about 0.1 μm to about 10 μm.

47. A printed image as in claim 46, wherein the alkali metal concentration in the ink-receiving layer applied as a topcoat is greater than is present in the coated media substrate.
